(19) United States
(12) Patent Application Publication
(10) Pub. No.: US 2009/0070739 A1
(43) Pub. Date: Mar. 12, 2009

(54) System and method of communicating between heterogeneous systems

(76) Inventors: Ralf H. Philipp, Altlussheim (DE); Stephan Iig, Tiefenbach (DE); Prabhat Raman, Bangalore (IN); Matthias Woerner, Dielheim (DE)

Correspondence Address: KENYON & KENYON LLP, ONE BROADWAY, NEW YORK, NY, 10004, US

(21) Appl. No.: 11/900,733

(22) Filed: Sep. 12, 2007

(51) Int. Cl. G06F 9/44

(52) U.S. Cl. 717/116

(57) ABSTRACT

A method and system are provided for communicating between two heterogeneous systems in an enterprise services architecture. A software object on a first system is associated with a node, a node attribute, an action, and a query. The software object is then formatted, or converted, into a generic version of the software object before contact with a user interface of a second system. The contact with the user interface of the second system is then made.

### BACKGROUND

In enterprise service architectures, communication via a graphical user interface may be limited by the pre-conditions, i.e., communication requirements, of the graphical user interface. Specifically, elements or software objects which contact the graphical user interface may not be compatible with the graphical user interface, and thus may need to be controlled or manipulated depending upon its pre-conditions. In some systems, the software object may be mapped into a graphical component in order to solve any compatibility issues between the graphical user interface and the software object.

Accordingly, software objects currently modeled and used in business applications are unsuitable to fulfil the needs of the graphical user interface (UI) and do not support the communication protocol required. Moreover, the present solutions provide for a slow response time given the mapping required in order to communicate with the UI. Thus, a need exists to provide a generic software object which can communicate with the UI in a more efficient and compatible manner.

### BRIEF DESCRIPTION OF THE DRAWINGS

FIG. 1 shows an example service-oriented architecture structure.

FIG. 2 shows an example structure of a GANTT-software object in accordance with an embodiment of the present invention.

FIG. 3 shows an example system in accordance with an embodiment of the present invention.

FIG. 4 shows an example system in accordance with an embodiment of the present invention.

FIG. 5 shows an example generic business object in accordance with an embodiment of the present invention.

FIG. 6 shows an example GANTT chart in accordance with an embodiment of the present invention.

FIG. 7 shows an example work breakdown structure in accordance with an embodiment of the present invention.

FIG. 8 shows an example network structure in accordance with an embodiment of the present invention.

FIG. 9 shows an example business object structure in accordance with an embodiment of the present invention.

### DETAILED DESCRIPTION

Development of a complex software system may involve defining an object model that represents the desired structure and functionality of objects to be implemented in an application framework. In business software environments, such as in enterprise service architecture systems, those software objects may be referred to as business objects which can be defined according to a node structure that may specify corresponding data elements and behaviors to be associated with the business objects. Once the object model is defined, developers may produce code for the application framework that implements the defined objects. The application framework acts as a service provider and generally provides the service-side or business logic side or back-end level functionality for the system. The client-side or front-end aspects of the system are then coded, including the user interface portion, e.g., graphical user interface (UI), providing specific application contexts and usage scenarios which depend upon the backend level functionality. These specific application contexts and usage scenarios are the pre-conditions. The business objects along with their corresponding data elements and behaviors may encounter a graphical UI of a software system which straddles two separate and incompatible software systems.

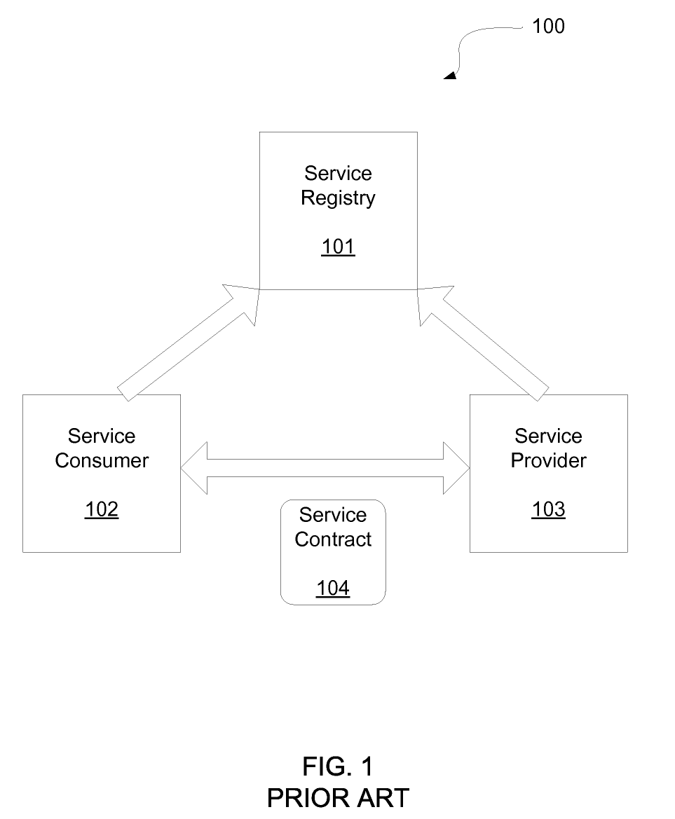

FIG. 1 shows an example of the elements of a service-oriented architecture (SOA). SOA 100 is a peer-to-peer architecture supporting services connecting providers and consumers. The elements of SOA include a service provider 103, a service registry 101, a service consumer 102, and a service contract 104. The service contract 104 is a contract binding the consumer with a service provider. The service registry is the record of services information, e.g., new services available, etc.

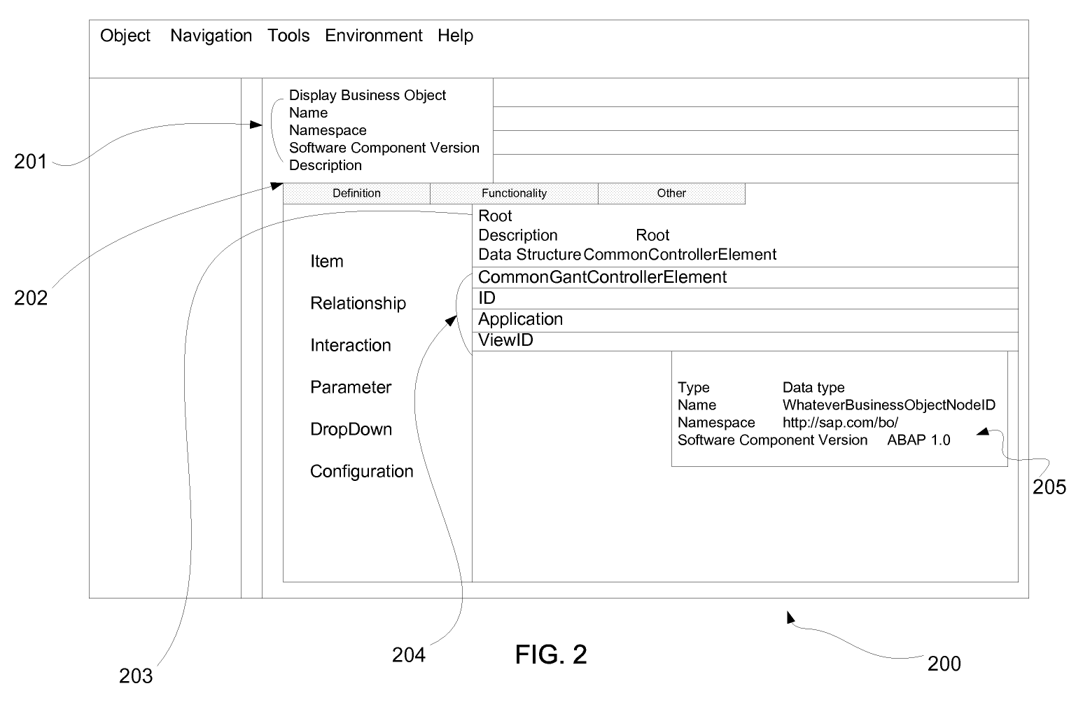

FIG. 2 shows an example structure of a GANTT business object. Typically, a GANTT chart represents a project schedule, illustrating in a bar chart start and finish dates of terminal elements, for example, of a project. A GANTT chart may also show the dependency relationships between activities. For example, a GANTT chart may represent the phases and activities of a project work breakdown structure (WBS), where a summary of terminal elements may be shown, including all of their associated activities and percentage of activities completed. In FIG. 2, a GANTT business object is shown in which the business object structure is displayed 200. In a first section 201 of the screen, the name, namespace, software component version, and description of the business object is stored. The tabs provided on the second section of the screen, allow for selection of various information such as Definition, among others, which may, as shown, identify the business object node 202 associated with the business object. Within the business object node screen, one may access various information regarding the business object, including relationship to other objects, parameters, collaboration, etc. In the present embodiment, the relationship information is selected. Accordingly, the root node 203 is identified, including a description, and data structure. Further the root node 203 includes information on the common Gantt controller element 204, and the like. The root node also may identify 205 its associated type, name, namespace, and software component version.

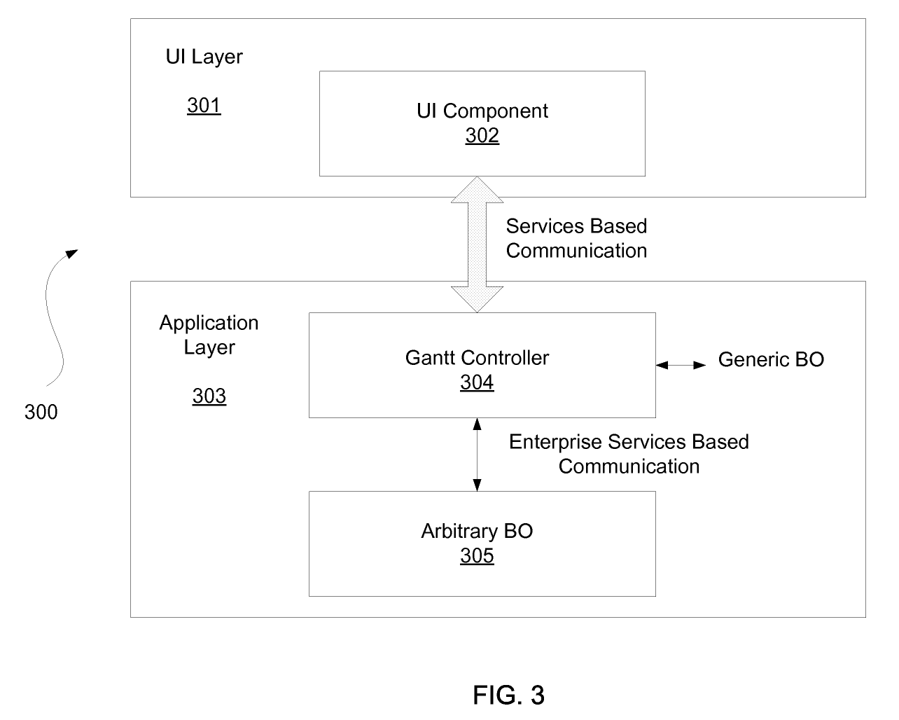

FIG. 3 shows an example system 300 in accordance with the present invention. In the application layer 303, an arbitrary business object 305 is available. The business object 305 is modeled from and/or associated with a project or production order. Via enterprise services based communication, the business object communicates with the Gantt controller 304. The Gantt controller 304 converts—all within the application layer and before contacting the user interface layer—the business object into a generic business object which can communicate with the user interface layer 301. The user interface layer 301 includes a user interface component 302. The user interface component 302 includes the preconditions of the user interface and communicates via services based communication. The user interface component 302 may receive the generic business object and use it to generate, for example, a Gantt model or chart showing a project schedule, a network showing the relationships between entities, e.g., business objects, and/or a work breakdown structure (WBS) which defined and organizes the total scope of a project using a hierarchical tree structure. In embodiments of the present invention, the backend contains the business logic. That business logic is a prerequisite for the generic business object and communication protocol. Given the translation of the business object in the backend before contact with the user interface outside the backend software system, the processing time is rather quick. For example, a possible backend system may be coded with ABAP code, C++, or other code. The user interface side may be coded in Java.

In another embodiment of the present invention, a generic process for obtaining a generic business object is provided. The generic process may involve opening a user interface which has nongraphical user interface components and works on the business object and a controller object, and converting a transit node of the business object into a Gantt business object. The Gantt business object will then be responsible for all conversions.

In embodiments of the present invention, one business object can be in contact with more than one user interface.

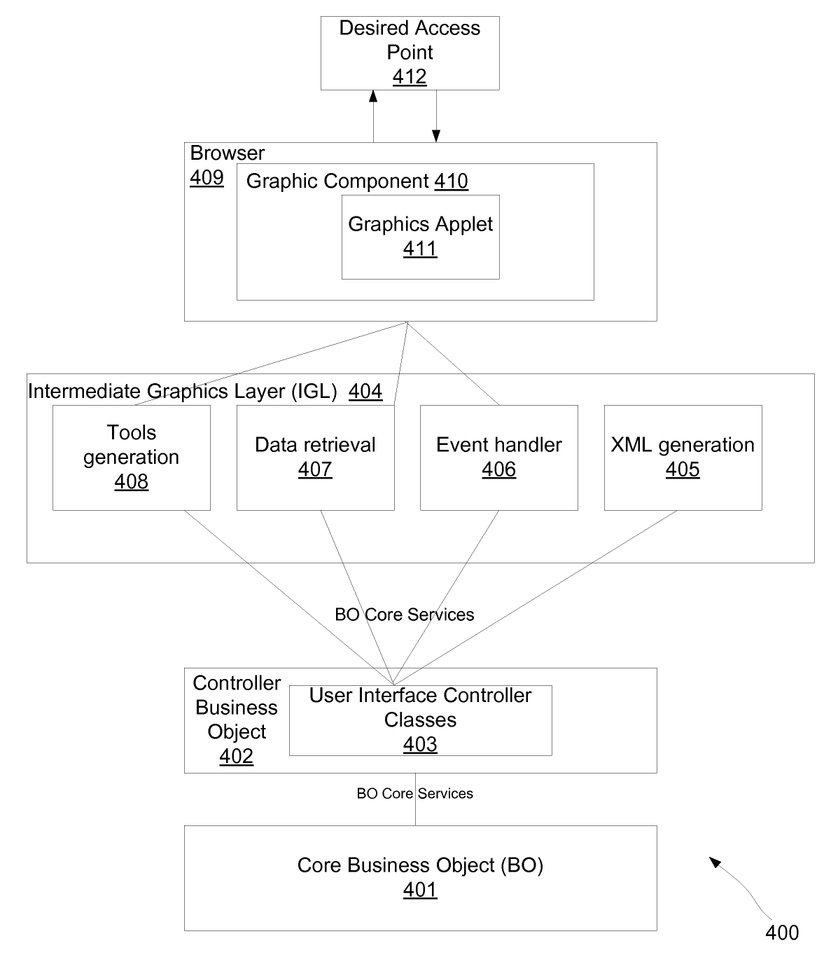

FIG. 4 shows an example system 400 in accordance with the present invention. The core business object or arbitrary business object 401 provides business object core services to controller business object 402. The controller business object 402 contains the its associated controller classes 403. The business object 401 and the controller object 402 exist on the backend of an enterprise software system or other. For example, the backend and front-end (including a user interface) systems may be coded in at least one of the following ABAP, C++, Java, flash macromedia, net-based, or other computer language. In FIG. 4, the controller business object communicates core services with an intermediate graphics layer (IGL) 404. The intermediate graphics layer 404 may include, for example and among other things, an XML generator 405, an event handler 406, data retrieval 407, and tools generation 408. The intermediate graphics layer communicates with the graphic component 410 having a graphics applet 411. The browser 410 may contain the graphic component 410 in communication with the intermediate graphics layer 404.

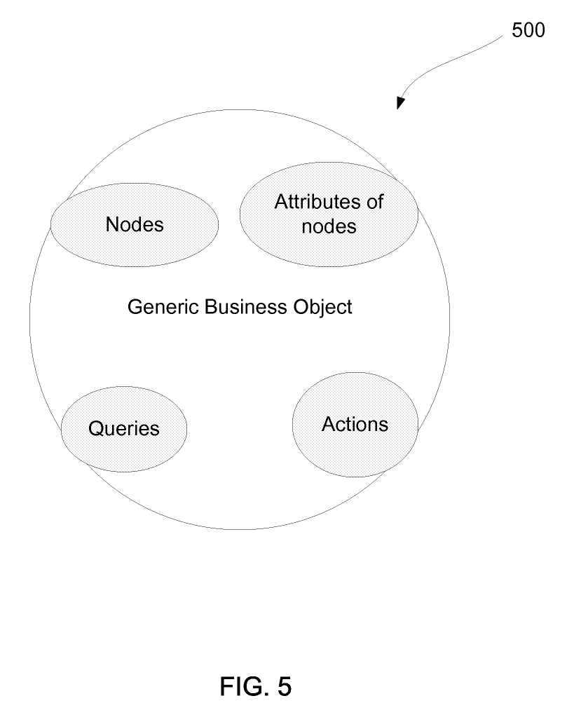

FIG. 5 shows an example generic business object 500 according to an embodiment of the present invention. The generic business object 300 includes nodes, attributes of nodes, action, and queries, according to the needs of a graphical component. This generic business object is compliant with service-oriented architecture (SOA) contracts. This generic business object can mediate between graphical user interface elements and an arbitrary set of application business objects. Example business objects may include project and production order.

In an embodiment of the present invention, the basic architecture involves the backend system implementing the business logic. Any rendering is executed in the user interface component, where the rendering information is passed from the business logic via a generic business object to the user interface component. The system controls information about the toolbars, actions, size and shape of a node, and the relationships between the nodes. For example, the size and shape of a node may be represented as a bar in a Gantt chart. In an embodiment of the present invention, this information is transported from the backend to the user interface. The backend and the user interface may be based on two different coding languages and methods. The user interface via, for example, a Java applet, may handle such transported information. This interface may be termed an intermediate graphics layer, as shown in FIG. 3.

In an embodiment of the present invention, a communication protocol exists between the generic business object, e.g., the Gantt business object shown in FIG. 1, and the graphical user interface component. The generic business object is the transformation of an arbitrary structure business object having nodes, attributes, queries, and action, into a unified format which would be recognizable outside the backend. The generic business object is tasked with passing data in the unified format to the graphical component on the front end. The data may be categorized as, for example, metadata and interaction data. The metadata may include the type of element. The interaction data may include allowed actions. This data may be used for the graphical elements, for example, the bars, edges, and the connectors.

In an embodiment of the present invention, the generic business object may handle an event triggered by the graphical user interface. The generic business object may also handle the dispatching or delegation of the event, after a transformation, to the underlying application business object. The generic business object also may control the layout or properties of the graphical user interface including, for example, colors and date format.

The GANTT business object in an enterprise service repository for purposes of embodiments of the present invention may comprise a “generic business object” structure and is used for providing data for the resulting graphical views. Such graphical views include a GANTT chart, a work breakdown structure, a network diagram, and a table. An example GANTT business object, e.g., ProjectGanttController, as shown in various embodiments herein, may include the following structure:

Root Node
Attributes

| Name | Category | Type | Occurrence |
|---|---|---|---|
| ID | Element | CommonGanttID | 1 |
| AppNodeID | Element | CommonBusinessObjectNodeID | 0 . . . 1 |
| ViewID | Element | CommonGanttViewID | 0 . . . 1 |

Actions
<not applicable>
Associations

| Name | Target BO | TargetBONode |
|---|---|---|
| Item | ProjectGanttController | Item |
| Column | ProjectGanttController | Column |
| Interaction | ProjectGanttController | Interaction |
| Configuration | ProjectGanttController | Configuration |
| ProjectSnapshot | ProjectSnapshot | Root |
| ProjectTemplate | ProjectTemplate | Root |
| ProjectBaseline | ProjectBaseline | Root |

Queries

Name
SelectAll
SelectByViewID

Item Node
Attributes

| Name | Category | Type | Occurrence |
|---|---|---|---|
| Selected | Element | p1: Indicator | 1 |
| Collapsed | Element | p1: Indicator | 1 |
| ParentItem | Element | CommonBusinessObjectNodeID | 1 |
| NavigationNodeID | Element | CommonBusinessObjectNodeID | 1 |
| Icon | Element | CommonGanttStringValue | 1 |
| Name | Element | p1: LANGUAGEINDEPENDENT_MEDIUM_Name | 0 . . . 1 |
| AttachmentIcon | Element | CommonGanttStringValue | 0 . . . 1 |
| ObjectType | Element | p1: LANGUAGEINDEPENDENT_MEDIUM_Name | 1 |
| RiskIcon | Element | CommonGanttStringValue | 0 . . . 1 |
| ChecklistAvailableIndicator | Element | p1: Indicator | 0 . . . 1 |
| BlockedIndicator | Element | p1: Indicator | 0 . . . 1 |
| LifecycleStatusName | Element | p1: LANGUAGEINDEPENDENT_MEDIUM_Name | 0 . . . 1 |
| Responsible | Element | p1: LANGUAGEINDEPENDENT_LONG_Name | 0 . . . 1 |
| PlannedDuration | Element | p1: Duration | 0 . . . 1 |
| Services | Element | CommonGanttStringValue | 1 |
| TeamMembers | Element | CommonGanttStringValue | 1 |
| PlannedWorkQuantity | Element | p1: Quantity | 1 |
| unitCode | Attribute | p2: MeasureUnitCode | optional |
| PlannedWorkAggQuantity | Element | p1: Quantity | 1 |
| unitCode | Attribute | p2: MeasureUnitCode | optional |
| RemainingWorkQuantity | Element | p1: Quantity | 1 |
| unitCode | Attribute | p2: MeasureUnitCode | optional |
| RemainingWorkAgg | Element | p1: Quantity | 1 |
| Quantity | | | |
| unitCode | Attribute | p2: MeasureUnitCode | optional |
| ActualWorkQuantity | Element | p1: Quantity | 1 |
| unitCode | Attribute | p2: MeasureUnitCode | optional |
| ActualWorkAggQuantity | Element | p1: Quantity | 1 |
| unitCode | Attribute | p2: MeasureUnitCode | optional |
| TotalFloatDuration | Element | p1: Duration | 1 |
| EarliestPlannedPeriod | Element | CommonGanttUPPEROPEN_LOCALNORMALISED_DateTimePeriod | 1 |
| StartDateTime | Element | CommonGanttLocalNormalisedDateTime | 0 . . . 1 |
| LocalNormalisedDate | Element | p2: LOCALNORMALISED_DateTime | 1 |
| Time | | | |
| timeZoneCode | Attribute | p2: TimeZoneCode | required |
| TimeFormat | Element | CommonGanttTimeFormatCode | 1 |

enumeration = “none, hoursAndMinutes, hoursMinutesAndSeconds”

| | | | |
|---|---|---|---|
| EndTimeIndicator | Element | CommonGanttEndTimeIndicator | 1 |
| EndDateTime | Element | CommonGanttLocalNormalisedDateTime | 0 . . . 1 |
| LocalNormalisedDate | Element | p2: LOCALNORMALISED_DateTime | 1 |
| Time | | | |
| timeZoneCode | Attribute | p2: TimeZoneCode | required |
| TimeFormat | Element | CommonGanttTimeFormatCode | 1 |

enumeration = “none, hoursAndMinutes, hoursMinutesAndSeconds”

| | | | |
|---|---|---|---|
| EndTimeIndicator | Element | CommonGanttEndTimeIndicator | 1 |
| LatestPlannedPeriod | Element | CommonGanttUPPEROPEN_LOCALNORMALISED_DateTimePeriod | 1 |
| StartDateTime | Element | CommonGanttLocalNormalisedDateTime | 0 . . . 1 |
| LocalNormalisedDate | Element | p2: LOCALNORMALISED_DateTime | 1 |
| Time | | | |
| timeZoneCode | Attribute | p2: TimeZoneCode | required |
| TimeFormat | Element | CommonGanttTimeFormatCode | 1 |

enumeration = “none, hoursAndMinutes, hoursMinutesAndSeconds”

| | | | |
|---|---|---|---|
| EndTimeIndicator | Element | CommonGanttEndTimeIndicator | 1 |
| EndDateTime | Element | CommonGanttLocalNormalisedDateTime | 0 . . . 1 |
| LocalNormalisedDate | Element | p2: LOCALNORMALISED_DateTime | 1 |
| Time | | | |
| timeZoneCode | Attribute | p2: TimeZoneCode | required |
| TimeFormat | Element | CommonGanttTimeFormatCode | 1 |
| EndTimeIndicator | Element | CommonGanttEndTimeIndicator | 1 |
| CompletionPercent | Element | p1: SMALLNONNEGATIVEINTEGER_Percent | 1 |
| ImportanceCode | Element | p1: LANGUAGEINDEPENDENT_MEDIUM_Name | 1 |
| CompletionPercent | Element | p1: SMALLNONNEGATIVEINTEGER_Percent | 1 |
| Agg | | | |
| ActualStartDateTime | Element | CommonGanttLocalNormalisedDateTime | 1 |
| LocalNormalisedDate | Element | p2: LOCALNORMALISED_DateTime | 1 |
| Time | | | |
| timeZoneCode | Attribute | p2: TimeZoneCode | required |
| TimeFormat | Element | CommonGanttTimeFormatCode | 1 |

enumeration = “none, hoursAndMinutes, hoursMinutesAndSeconds”

| | | | |
|---|---|---|---|
| EndTimeIndicator | Element | CommonGanttEndTimeIndicator | 1 |
| ActualFinishDateTime | Element | CommonGanttLocalNormalisedDateTime | 1 |
| LocalNormalisedDate | Element | p2: LOCALNORMALISED_DateTime | 1 |
| Time | | | |
| timeZoneCode | Attribute | p2: TimeZoneCode | required |
| TimeFormat | Element | CommonGanttTimeFormatCode | 1 |

enumeration = “none, hoursAndMinutes, hoursMinutesAndSeconds”

| | | | |
|---|---|---|---|
| EndTimeIndicator | Element | CommonGanttEndTimeIndicator | 1 |
| EmployeeUUID | Element | p1: UUID | 1 |
| GreyQut | Element | p1: Indicator | 1 |

Actions
<not applicable>
Associations

| | | |
|---|---|---|
| Bar | ProjectGanttController | Bar |
| Item | ProjectGanttController | Item |
| AllowedParentItem | ProjectGanttController | Item |
| ForbiddenParentItem | ProjectGanttController | Item |

Queries
<not applicable>

Bar Node
Attributes

| | | | |
|---|---|---|---|
| StartDate | Element | CommonGanttLocalNormalisedDateTime | 1 |
| LocalNormalisedDateTime | Element | p1: LOCALNORMALISED_DateTime | 1 |
| timeZoneCode | Attribute | p1: TimeZoneCode | required |
| TimeFormat | Element | CommonGanttTimeFormatCode | 1 |
| EndTimeIndicator | Element | CommonGanttEndTimeIndicator | 1 |
| EndDate | Element | CommonGanttLocalNormalisedDateTime | 1 |
| LocalNormalisedDateTime | Element | p1: LOCALNORMALISED_DateTime | 1 |
| timeZoneCode | Attribute | p1: TimeZoneCode | required |
| TimeFormat | Element | CommonGanttTimeFormatCode | 1 |
| EndTimeIndicator | Element | CommonGanttEndTimeIndicator | 1 |
| Type | Element | CommonGanttBarType | 1 |
| Tooltip | Element | p2: Indicator | 1 |
| TooltipText | Element | p2: LANGUAGEINDEPENDENT_Text | 1 |
| PercentageOfCompetion | Element | p2: SMALLNONNEGATIVEINTEGER_Percent | 1 |
| Moveable | Element | p2: Indicator | 1 |
| SizeableStart | Element | p2: Indicator | 1 |
| SizeableEnd | Element | p2: Indicator | 1 |
| LabelText | Element | p2: LANGUAGEINDEPENDENT_Text | 1 |
| Selected | Element | p2: Indicator | 1 |
| CreateRelations | Element | p2: Indicator | 1 |

Actions
<not applicable>
Associations

| | | |
|---|---|---|
| Relationship | ProjectGanttController | Relationship |

Queries
<not applicable>

Relationship Node
Attributes

| | | | |
|---|---|---|---|
| FromID | Element | CommonBusinessObjectNodeID | 1 |
| ToID | Element | CommonBusinessObjectNodeID | 1 |
| Type | Element | p1: NetworkPlanElementSuccessionTypeCode | 1 |
| Selected | Element | p1: Indicator | 1 |
| EdgeType | Element | CommonGanttEdgeType | 1 |
| LabelType | Element | p1: LANGUAGEINDEPENDENT_Text | 1 |
| Editable | Element | p1: Indicator | 1 |

Actions
<not applicable>
Associations
<not applicable>
Queries
<not applicable>

Interaction Node
Attributes

| | | | |
|---|---|---|---|
| BackendActionRequired | Element | p1: Indicator | 1 |
| JGanttCommand | Element | p1: LANGUAGEINDEPENDENT_Name | 1 |
| InteractionName | Element | p1: LANGUAGEINDEPENDENT_MEDIUM_Name | 1 |
| Type | Element | CommonGanttInteractionTypeCode | 1 |
| Position | Element | CommonGanttInteractionPosition | 1 |
| SpacingAfter | Element | p1: Indicator | 1 |
| Icon | Element | CommonGanttStringValue | 1 |
| Tooltop | Element | CommonGanttStringValue | 1 |
| Disabled | Element | p1: Indicator | 1 |

Actions
Action Name
Execute
Associations

| | | |
|---|---|---|
| Parameter | ProjectGanttController | Parameter |
| InteractionDropDown | ProjectGanttController | InteractionDropDown |

Queries
<not applicable>

Parameter Node
Attributes

| | | | |
|---|---|---|---|
| Parameter | Element | CommonGanttStringValue | 1 |
| Value | Element | CommonGanttStringValue | 1 |

Actions
<not applicable>
Associations
<not applicable>
Queries
<not applicable>

InteractionDropDown Node
Attributes

| | | | |
|---|---|---|---|
| Selected | Element | p1: Indicator | 1 |
| Value | Element | CommonGanttStringValue | 1 |
| JGanttCommand | Element | p1: | 1 |
| | | LANGUAGEINDEPENDENT_Name | |

Actions
<not applicable>
Associations
<not applicable>
Queries
<not applicable>

Configuration Node
Attributes

| | | | |
|---|---|---|---|
| Name | Element | p1: LANGUAGEINDEPENDENT_Name | 1 |
| Index | Element | CommonGanttConfigurationIndex | 1 |
| RefToIndex | Element | CommonGanttConfigurationIndex | 1 |
| Value | Element | CommonGanttStringValue | 1 |

Actions
<not applicable>
Associations
<not applicable>
Queries
<not applicable>

Column Node
Attributes

| | | | |
|---|---|---|---|
| ColumnId | Element | p1: LANGUAGEINDEPENDENT_MEDIUM_Name | 1 |
| HeaderName | Element | p1: LANGUAGEINDEPENDENT_MEDIUM_Name | 1 |
| Type | Element | CommonGanttColumnTypeCode | 1 |

enumeration = “header, tree, label, combo, icon, date”

| | | | |
|---|---|---|---|
| TypeVal | Element | CommonGanttStringValue | 1 |
| Width | Element | CommonGanttStringValue | 1 |
| InputLength | Element | CommonGanttValue | 1 |
| Position | Element | CommonGanttColumnPosition | 1 |

Actions
<not applicable>
Associations
<not applicable>
Queries
<not applicable>

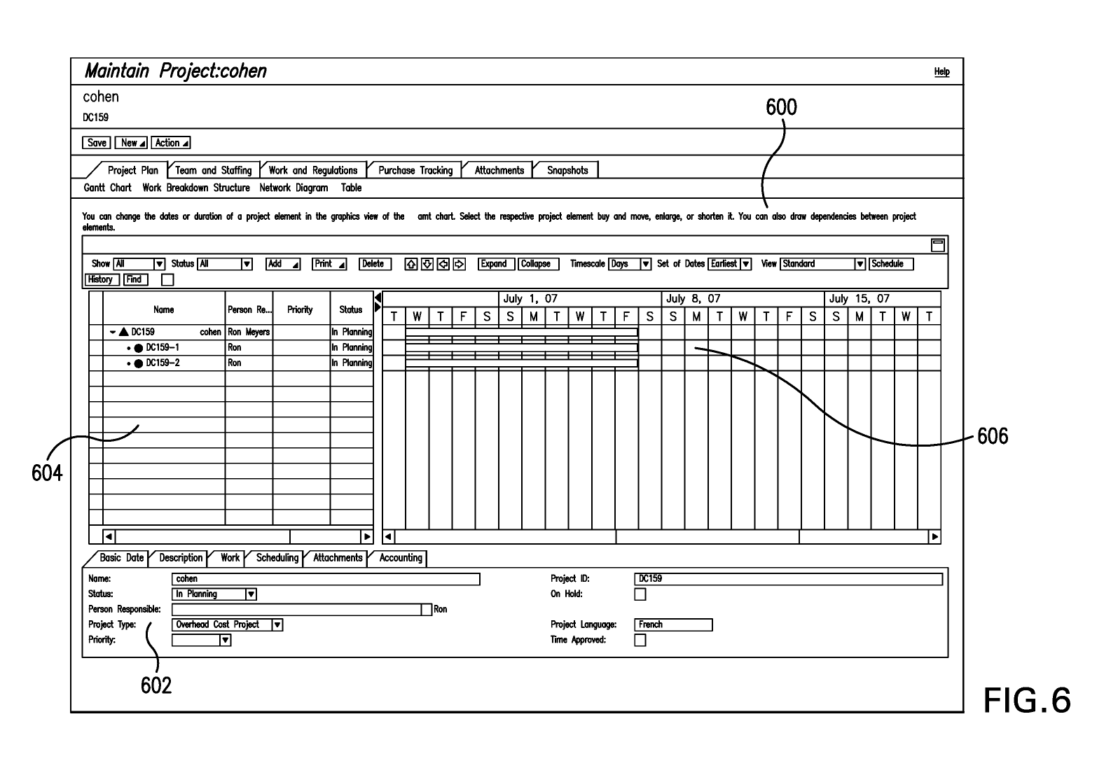

FIG. 6 illustrates an example GANTT chart 600 in accordance with an embodiment of the present invention. The GANTT chart 600 may display a name for the object, a person responsible, the priority of the associate object, the status, and other details. For example, basic data 602 of the GANTT chart 600 may include information which may be inputted via an open field or drop-down menu selection. Such information may include name, status (e.g., “in planning”, “completed”), person responsible (e.g., identifier, a person's name), project type (e.g., “overhead cost project”), and priority. Other information may include the project identifier (e.g., DC159—which may be identified in the GANTT chart 600 in a separate area 604 for display—this separate area of display 604 shows the attributes of the nodes), project language (e.g., French), on hold indicator, time approval indicator, and other matters. In the GANNT chart 600, the time schedule 606 may be displayed using graphical bars showing the requisite information. In this embodiment, the time et al. may be set by the controller object. In this embodiment, one may modify the dates and/or duration of a project element in the graphical view of the GANTT chart. For example, one may select the respective project element bar and move, enlarge, or shorten it. And, dependencies may be drawn between the project elements.

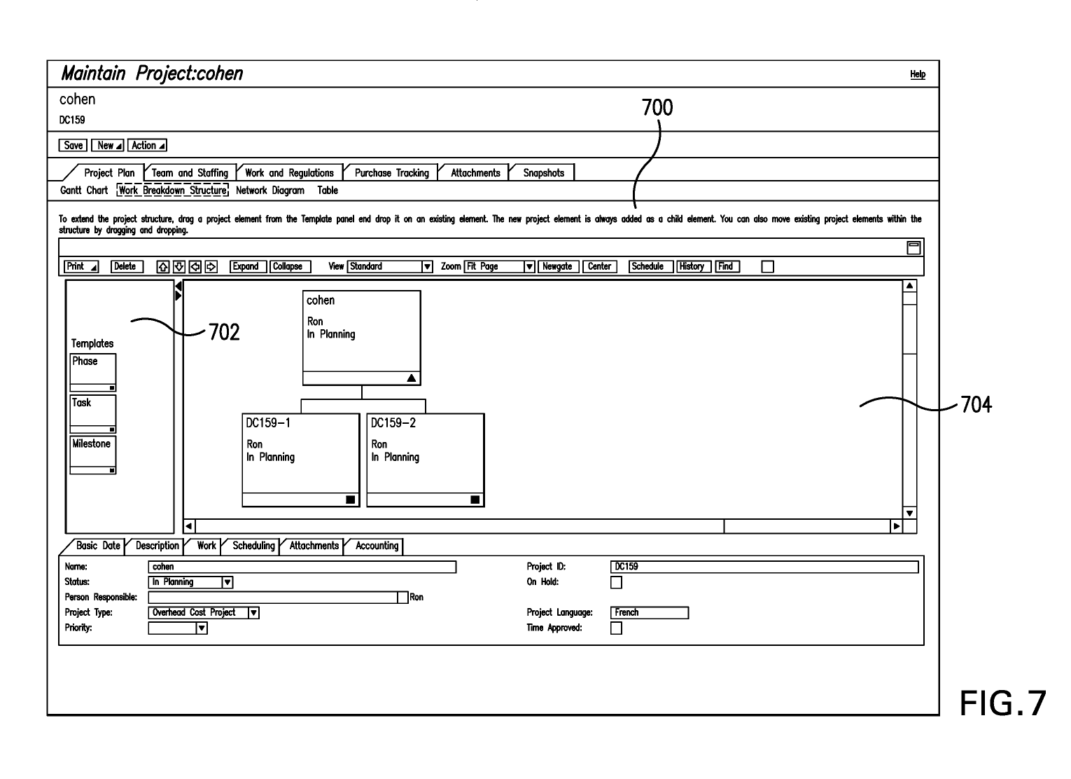

FIG. 7 illustrates an example work breakdown structure 700 in accordance with an embodiment of the present invention. In FIG. 7, the work breakdown structure may include a display of the possible templates 702. For example, possible templates may include a phase template, task template, and/or milestone template, among others. The work breakdown structure also may include a display of the actual work breakdown between entities 704. For example, the name of the object may be displayed with the information of the status and person(s) responsible in a graphical view. This graphical view may indicate the relations between the sub-workflow matters (e.g., DC159-1 and DC159-2).

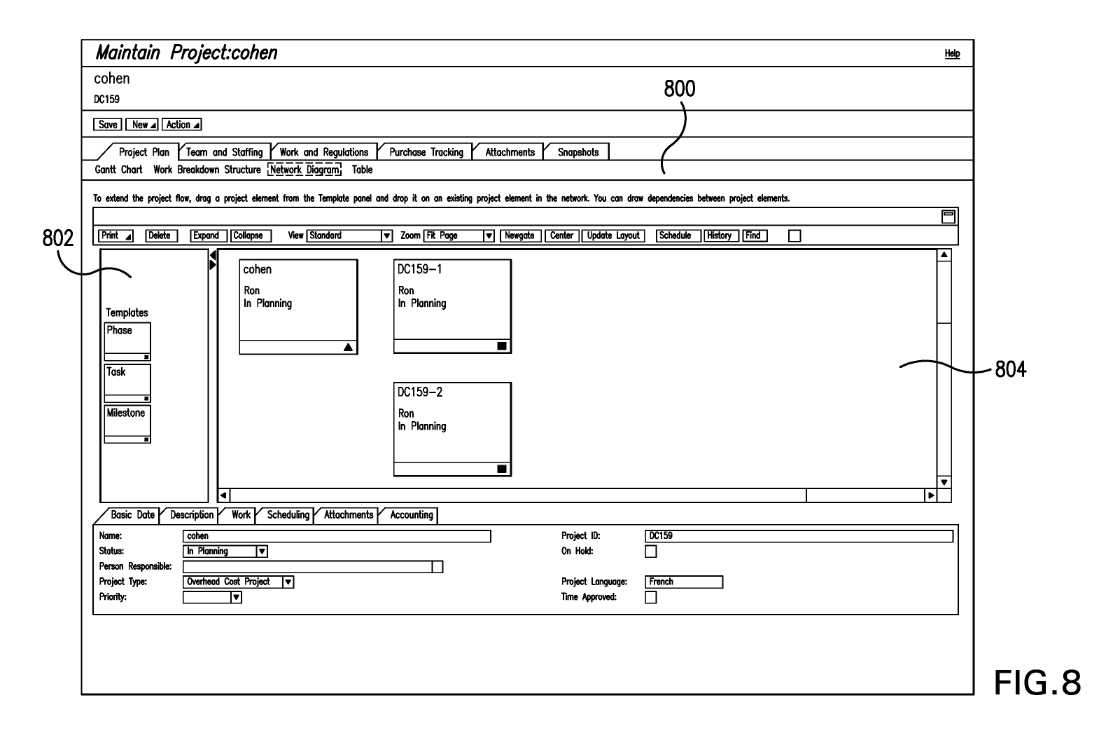

FIG. 8 illustrates an example network diagram or structure 800 in accordance with an embodiment of the present invention. In FIG. 8, the network diagram 800 may include a display of the templates 802. For example, possible templates may include a phase template, task template, and/or milestone template. The network diagram of the different entities 804 may display their network relationship via a shape in the lower right hand portion of each graphical text box. For example, the two boxes stemming from the main cohen box indicate their network status with an oval shape in the lower right hand corner, while the main cohen box indicates its network status with a triangle shape. Various other information may be displayed as shown and as might be contemplated. Dependencies between the project elements shown by the graphical text boxes may be drawn.

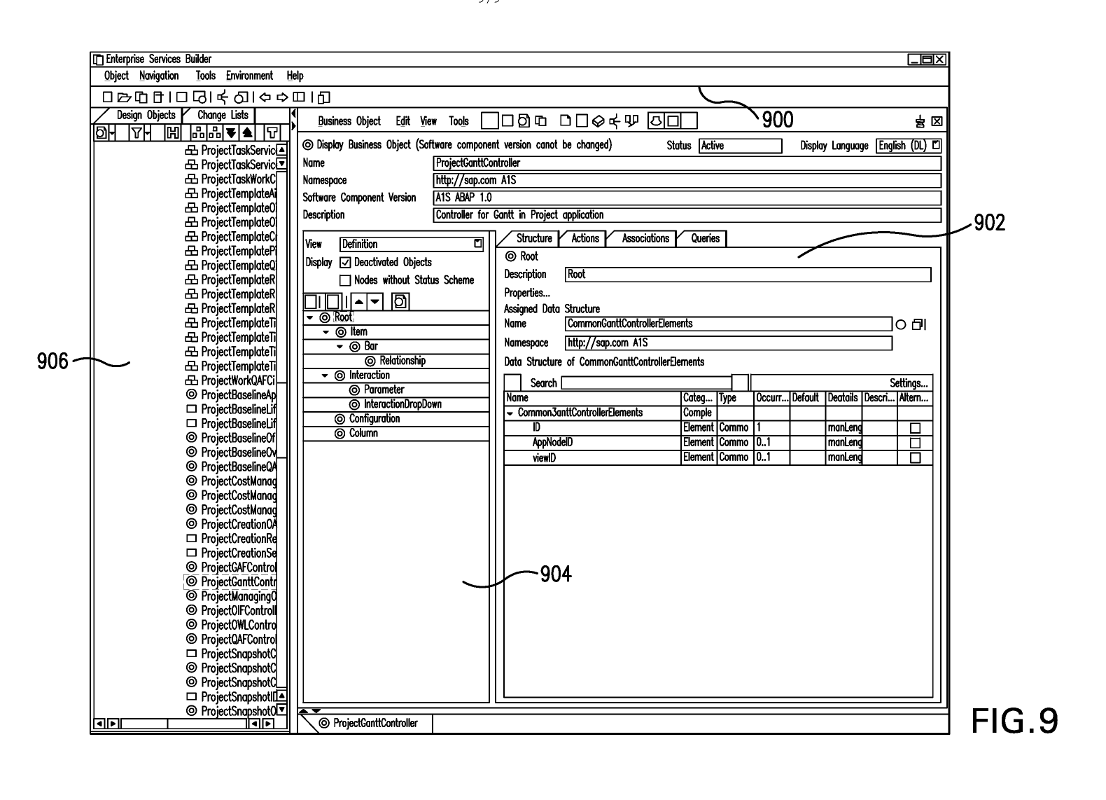

FIG. 9 illustrates an example structure of a GANTT controller business object 900 in accordance with an embodiment of the present invention. The business object displayed has a structure indicated by the screen 902 which indicates the description of the object, e.g., root, the properties of the object, the assigned data structure of the object including the name and namespace or location of same, and the associated data structure description. A screen 904 may also indicate in a different view the various features of the root in a different fashion, including the item and any associated bar and relationship information, the interaction having an associated parameter and interactiondropdown menu option, configuration, and column information. A screen 906 may also be displayed indicate, for example, a list of design objects, or other lists that may be displayed upon user request and/or a predefined request.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. Features and embodiments described above may be combined with each other in various ways providing further embodiments. The present application is therefore contemplated to cover any and all modifications, variations, combinations or equivalents that fall within the scope of the basic underlying principals disclosed and claimed herein.

What is claimed is:

1. A method for communicating between at least two systems, comprising:
providing a software object, the software object having at least one of an associated node, an attribute associated with the associated node; an action; and a query;
formatting the software object into a generic software object;
communicating by the generic software object with a user interface, the user interface interfacing between the at least two systems.

2. The method of claim 1, wherein the at least two systems include a client-side and a business logic side of a services-oriented architecture.

3. The method of claim 2, wherein the at least two systems are heterogeneous.

4. The method of claim 3, wherein the formatting the software object into a generic software object is effected by a controller object located in the same system as the software object.

5. The method of claim 4, wherein the controller object formats the information associated with the software object, outputting at least one of: toolbar, action, size and shape of node, bar, attributes of a node, item, and relationship between nodes.

6. The method of claim 5, wherein the second system is coded with Java language, and the first system is coded with a different computer language.

7. The method of claim 5, wherein the formatted information associated with the generic software object is transported from the first system to the user interface on the second system.

8. A system for communicating between at least two systems, comprising:
a software object located in a first system, the software object having at least one of an associated node, an attribute associated with the associated node; an action; and a query;
a controller object located in the first system; and
a user interface located in the second system,
wherein the controller object formats the software object into a generic software object while in the first system, the generic software object being capable of communicating with the user interface.

9. The system of claim 8, wherein the user interface interfaces between the first and second systems, the at least two systems including a client-side and a service-side of an enterprise services architecture.

10. The system of claim 8, wherein the controller object formats the information associated with the software object, the information including at least one of: toolbar, action, size and shape of node, bar, and relationship between nodes.

11. The method of claim 10, wherein the formatted information associated with the generic software object is transported from the first system to the user interface on the second system.

12. A computer-readable medium including instructions adapted to execute a method for communicating between at least two systems, the method including, providing a software object, the software object having at least one of an associated node, an attribute associated with the associated node; an action; and a query;
formatting the software object into a generic software object; and
then communicating by the generic software object with a user interface, the user interface interfacing between the at least two systems.

13. The computer-readable medium of claim 12, wherein the formatting the software object into a generic software object is effected by a controller object located in the same system as the software object.

14. The computer-readable medium of claim 13, wherein the controller object formats the information associated with the software object, the information including at least one of: toolbar, action, size and shape of node, bar, and relationship between nodes.

15. The computer-readable medium of claim 14, in the formatted information associated with the generic software object is transported from the first system to the user interface on the second system.

16. The computer-readable medium of claim 12, wherein the second system is coded with Java language, and the first system is coded with a different computer language.

17. The computer-readable medium of claim 12, wherein the client-side is coded using at least one of Java language, flash macromedia, C++ language, Microsoft Platform, and net-based language.
